(19) United States
(12) Patent Application Publication
(10) Pub. No.: US 2014/0224729 A1
(43) Pub. Date: Aug. 14, 2014

(54) Method for the Sequenced Biological Treatment of Water Implementing Biomass Granules

(71) Applicant: Kim Sorensen, Jouy-Sur-Morin (FR)

(72) Inventor: Kim Sorensen, Jouy-Sur-Morin (FR)

(73) Assignee: Veolia Water Solutions & Technologies Support, Saint-Maurice Cedex (FR)

(21) Appl. No.: 14/127,992

(22) PCT Filed: Jun. 19, 2012
(86) PCT No.: PCT/EP2012/061694

§ 371 Date: Mar. 14, 2014

(30) Foreign Application Priority Data
Jun. 22, 2011 (FR) 1155482

(51) Int. Cl. C02F 3/30

(52) U.S. Cl. CPC C02F 3/301
USPC 210/605

(57) ABSTRACT

A method for biologically treating wastewater having organic matter is provided where the treatment occurs in a sequencing batch reactor having biomass granules therein. Wastewater to be treated is fed under anaerobic conditions into the reactor so as to fluidize the biomass granules. After feeding, the contents of the reactor are stirred. After stirring, the wastewater and biomass granules are subjected to aeration. Thereafter, the treated wastewater is decanted.

### 1. FIELD OF THE INVENTION

The field of the invention is that of the biological treatment of wastewater containing organic matter.

More specifically, the invention pertains to a technique for the sequenced biological treatment of water implementing biomass granules.

### 2. PRIOR ART

The carbon and nitrogen pollution contained in water, especially wastewater, is commonly reduced by means of biological treatments, for example of a sequenced type.

The sequenced biological treatment of water consists in treating a volume of water by putting it into contact, by successive portions, with biomass housed in a reactor. This type of reactor is called an SBR or Sequenced Batch Reactor.

The biomass degrades the carbon pollution during an aerobic phase. The ammonia is converted into nitrites during this aerobic phase by nitrification while the nitrates are degraded into nitrogen during an anoxic phase of denitrification.

It is then possible to collect treated water, with reduced carbon and nitrogen pollution, after it has been separated from the biomass.

The treated water is generally separated from the biomass involved in its treatment during a decantation or settling phase.

However, the biomass is situated in the water essentially in the form of small, particles of low decanting capacity, generally having a diameter of less than 1 mm. The result of this is that their decantation is slow. This means that the time needed for the biological treatment of water is relatively lengthy.

To overcome this drawback, other techniques have been devised for the sequenced biological treatment of water. These techniques consist in putting the water to be treated in contact with the biomass essentially taking the form of granules, the diameter of which is generally greater than 1 mm. The biomass granules which are bulkier and heavier than classic biomass particles have a high decanting capacity.

The implementing of such a technique for treating water has the advantage of reducing the time needed for the separation by decantation of the biomass and of the treated water and, as the case may be, the advantage of reducing the size of the apparatuses implemented for this purpose.

The European patent number EP-B1-1 542 932 describes a technique of this kind.

According to the technique described in this document, a bed of biomass granules is housed in a reactor.

The water to be treated is introduced into the base of the reactor during an anaerobic feeding operation. The rate at which water is fed to the reactor is chosen in such a way that the feeding is slow. This prevents the formation of a fluidized bed of biomass granules.

After completion of the operation for feeding the reactor with water for treatment, a phase of non-stirred latency is observed in the reactor during which the water to be treated is left in contact with the biomass granules. In this phase, the nutrients present in the water are assimilated by the biomass, the granules of which have their volume and density increasing accordingly.

Oxygen is then introduced into the reactor by means of a nozzle unit provided in its lower part. The nitrogen pollution contained in the water to be treated is then least partly degraded by nitrification-denitrification.

The granules are then extracted and then a decantation is carried within the reactor before extracting the treated water depleted of nitrogen pollution.

The technique described in this document makes it possible to reduce the concentration in water of nitrogen pollution and especially in phosphorous. It nevertheless has a few drawbacks.

### 3. DRAWBACKS OF THE PRIOR ART

The feeding of water to the reactor is slow in order to prevent the fluidizing of the bed of granules. The result of this is that the closer the granules are to the surface of the bed, the lesser the extent to which they are put into contact with the organic matter of the water to be treated on which they are nourished. There is therefore a vertical gradient of concentration in organic matter in the granules of the bed and therefore a non-uniform development of the granules.

To limit this phenomenon, the step of feeding is followed by a step of latency during which the content of the reactor is not stirred. The water to be treated is then kept in contact with the biomass granules for a sufficiently lengthy period of time to allow the granules situated in the upper layers of the bed enough time to assimilate the nutrients and grow in volume and density.

The inventors have nevertheless observed that these non-stirred phases of feeding and latency result in a reduced exchange between the nutrients present in the water and the biomass granules. This contributes to:

limiting the assimilation of nutrients by the granules and therefore reducing their development or growth as well as their decanting capacity;

limiting the depth of penetration of the nutrients in the granules and therefore reducing their stability, their resistance;

increasing the minimum concentration in organic matter that the water for treatment must contain in order to enable the generation of granules having high decanting capacity;

reducing the maximum concentration in organic matter that the water for treatment must contain;

increasing the duration of the anaerobic latency phase and the decantation phase and therefore the total duration of the treatment.

Besides, the biomass of which the granules are constituted comprise especially two types of microorganisms:

GAOs or glucose accumulative organisms;

PAOs or polyphosphate accumulative organisms.

It has been observed that the density of the PAOs is higher than that of the GAOs.

Thus, during the extraction of the granules, the PAOs, which are situated in the lower layers of the bed of granules, are extracted from the reactor in much greater proportions than the GAOs. The result of this is that the GAOs start competing with the PAOs and predominate within the reactor. This phenomenon has a negative impact on the level of elimination of the phosphorous contained in the water to be treated that is subsequently introduced into the reactor.

In addition to the granules, the water contained in the reactor comprises particles that have lower decanting capacity. These particles are discharged with the treated water extracted from the reactor. It is then necessary to carry out a polishing treatment downstream to the reactor. This tends to increase the size of the water treatment plants as well as the cost of the water treatment.

### 4. GOALS OF THE INVENTION

The invention is aimed especially at overcoming these drawbacks of the prior art.

More specifically, it is a goal of the invention to provide a technique for the biological treatment of water that contributes to improving the formation of the biomass granules.

In particular, it is a goal of the invention, in at least one embodiment, to procure a technique of this kind that enables the formation of solid and stable biomass granules.

It is another goal of the invention, in at least one embodiment, to provide a technique of this kind that improves the decantability of the biomass granules.

It is yet another goal of the invention, in at least one embodiment, to provide a technique of this kind that reduces the duration of biological treatment of water.

The invention further pursues the goal of providing, in at least one embodiment, a technique of this kind that maximizes the elimination of the pollution contained in the water to be treated.

The invention is also aimed, in at least one embodiment, at providing a technique of this kind that is versatile especially in that it ensures the treatment of different volumes of water having variable pollutant loads.

It is another goal of the invention, in at least one embodiment, to provide a technique of this kind that is simple to implement and/or reliable and/or economical.

### 5. SUMMARY OF THE INVENTION

These goals as well as others that shall appear here below are achieved by means of a method for treating wastewater containing organic matter within a reactor housing biomass granules and provided with aeration means.

According to the invention, such a method comprises a plurality of successive cycles each comprising:

an anaerobic step for feeding wastewater to said reactor during which said water is mixed with said granules to form a fluidized bed;

an anaerobic step for stirring the content of said reactor;

a step for aerating the content of said reactor;

a step of decantation;

a step for discharging treated water depleted of organic matter.

Thus, the invention relies on a wholly original approach according to which a water to be treated is introduced speedily into a reactor within which it is placed in contact with biomass granules in an anaerobic environment and then successive anaerobic phases are implemented for stirring the content of the reactor, and carrying out aeration, fast decantation and then extraction of treated water.

During the anaerobic phase of fast feeding of the reactor, the totality of the granules of the bed formed in the reactor are promptly brought into contact with the water to be treated. Then, a fluidization is observed of the bed of granules. This fluidization is maintained during the anaerobic stirring step. The granules are then distributed in an appreciably uniform manner and without stratification within the reactor.

The stirring generated within the reactor increases the exposure of the totality of the surface of each granule to the nutrients contained in the water to be treated.

The stirring of the granules within the reactor, starting from the feeding phase itself, improves the exchanges between the water and the granules. The result of this is that the rate of assimilation by the granules of nutrients initially present in the water, which is not limited by the diffusion, is increased. The granules formed then have a volume and a density that are greater than those obtained by the implementing of the technique according to the invention. Thus, the diameter of these granules generally ranges from 1 mm to 5 mm, whereas their density generally ranges from 1.02 to 1.10 kg/l. The granules formed then have a high decanting capacity.

Given the fact that the assimilation of nutrients within the granules is hardly limited by the diffusion, these nutrients can penetrate the granules in depth. The granules formed therefore have high stability.

The technique according to the invention leads to promoting the growth of the granules in proportions such that its implementation makes it possible to reduce the value of the minimum concentration in organic matter that the water to be treated must contain to enable the formation of solid granules of high decanting capacity. Thus, the technique of the invention generates the formation of solid granules of high decanting capacity from water, the minimum concentration of which in organic matter is of the order of 400 mg/l.

Inasmuch as the technique of the invention increases exchanges between the water to be treated and the granules, its implementation leads to improving the reduction of the organic matter contained in the water to be treated. The technique according to the invention therefore can be implemented to efficiently treat water whose concentration in organic matter is greater than 1500 mg/l.

Ultimately, the implementing of the technique according to the invention makes it possible especially to:

promote the development of voluminous and dense biomass granules;

reduce the duration of the phase during which the nutrients, especially glucose and phosphorous, present in the water are assimilated by the granules and therefore increase the speed of formation of the granules;

improve the stability of the biomass granules;

obtain a better distribution of biomass granules inside the reactor;

diminish the duration of the decantation phase;

improve the elimination of the pollution of the water to be treated;

reduce the overall duration of biological treatment of water.

According to one advantageous characteristic of the invention, the speed at which water is fed into the reactor during said step for feeding ranges from 10 to 20 m/h or m³/m²/h. This speed is preferably greater than 8 m/h or m³/m²/h.

Feeding water to the reactor at such a speed causes the bed of granules to be fluidized and thus improves the contact and therefore the exchanges between the nutrients present in the water and the biomass granules. Thus, this fosters the formation of stable and dense granules as soon as the reactor is filled. Naturally, the sole fact of choosing such a speed is not necessarily enough to obtain a fluidized bed. Other parameters must also be taken into account such as for example the size of the granules, their density and their surface condition. To improve the formation of a fluidized bed, the water must also feed the reactor, preferably in an appreciably homogenous way throughout its surface.

The speed at which water is fed can be expressed equally well in m/h or en m³/m²/h. In the latter case, m³ corresponds to a volume of water, whereas m² corresponds to the surface area of the reactor.

According to one preferred embodiment, said anaerobic step for stirring comprises a recirculation of at least a part of the water contained in said reactor from one zone of said reactor towards another.

This implementing generates a stirring within the reactor that is great enough to promote the growth of voluminous, solid and dense biomass granules, and small enough to maintain the integrity of the granules.

Preferably, the speed of recirculation will then range from 4 to 8 m/h.

According to another embodiment, said anaerobic step for stirring includes a swirling of the contents of said reactor by means of stirrers.

Such an implementation generates an adequate swirling of the content of the reactor in a simple and efficient manner.

Preferably, the level of stirring within said reactor during said anaerobic step of feeding ranges from 3 to 30 W/m³.

Advantageously, the level of stirring within said reactor during said anaerobic step for stirring ranges from 5 to 10 W/m³.

Such levels of stirring within the reactor foster the development of voluminous, solid and dense granules while at the same time preserving their integrity.

According to an advantageous embodiment, the level of the water discharge point during said step for discharging treated water depleted of organic matter is variable.

It is thus possible to gradually reduce the level starting from which the treated water is extracted during the step for extracting. The extraction of treated water can then begin without waiting for all the granules to be decanted. This reduces the time of extraction of the treated water.

This implementation also makes it possible to bring the bed of granules present at the bottom of the reactor closer to the level of the water extraction point and remove the particles with low decanting capacity that collect in the course of time on the surface of the upper layers of the granules of the bed.

This implementation can also permit the growth of a bed of granules of varying thickness at the bottom of the reactors so as to enable the treatment of water having varying levels of pollutant loads.

The level of the water extraction point can also be brought considerably closer to the surface to the bed of granules present at the bottom of the reactor. In this way, almost all the treated water depleted of organic matter can be extracted from the reactor. Thus, the concentration in organic matter inside the reactor is reduced at each new feeding operation in limiting the dilution of the water to be treated with the treated water stagnant in the reactor after extraction. The growth of the granules is thus promoted because they feed on the organic matter to grow.

According to an advantageous characteristic, a method according to the invention comprises a step for extracting granules, said step for extracting being preferably implemented after the running of several successive cycles.

This controls the development and the height of the bed of granules within the reactor as well as the age of the biomass that constitutes them. The choice of the height of the bed of granules enables the method to be adapted to the treatment of water having different levels of pollutant loads.

Said step for extracting is preferably preceded by a step for stirring said reactor.

The biomass constituting the granules comprises especially microorganisms called GAO (glucose accumulative organisms) and microorganisms called PAO (polyphosphate accumulative organisms). The GAOs which assimilate glucose are less dense than the PAOs which assimilate phosphorous. As a result, at the end of the decantation, the PAOs are situated in the lower levels of the bed of granules while the GAOs are situated in the upper layers of the bed of granules. Stirring the content of the reactor thus eliminates this stratification within the reactor and distributes the GAOs and the PAOs in an essentially uniform way within the reactor. Thus, during the extraction of the granules, the GAOs and the PAOs are extracted in substantially identical proportions. A predominance of the GAOs on the PAOs is then avoided at the following cycles thus maintaining an efficient level of reduction of phosphorus.

In this case, said step for stirring preferably comprises a step for aerating said reactor.

The fact of aerating the reactor before extracting the granules from it makes it possible not only to create a stirring therein but also to maintain an aerobic ambience and to prevent the phosphorous assimilated by the granules from escaping therefrom and getting distributed in the reactor before the granules are extracted from it. This implementation therefore improves the elimination of phosphorous.

According to one advantageous characteristic of the invention, at least one of said cycles comprises a step for extracting particles of low decanting capacity, said particles of low decanting capacity being not extracted with said treated water.

The extracted treated water is thus separated from the particles of low decanting capacity so that the treated water has a rate of solid particles in suspension that is low enough to avoid having to implement of a downstream polishing treatment. Only the extracted particles of low decanting capacity can be conveyed towards a treatment of this type. Thus, the cost of producing biologically treated water is limited

### 6. LIST OF FIGURES

Other features and advantages of the invention shall appear more clearly from the following description of a preferred embodiment, given by way of a simple illustratory and non-exhaustive example and from the appended drawings, of which:

FIG. 1 illustrates a first example of a plant for treating water to implement a method according to the invention;

FIG. 2 illustrates a second example of a plant for treating water to implement a method according to the invention.

### 7. DESCRIPTION OF ONE EMBODIMENT OF THE INVENTION

### 7.1. REMINDER OF THE GENERAL PRINCIPLE OF THE INVENTION

The general principle of the invention consists in treating water by biological means and introducing it rapidly during a phase of anaerobic feeding into a reactor within which it is put into contact with biomass granules. The water therein then undergoes successive anaerobic phases of swirling of the contents of the reactor, aeration, and then fast decantation. Treated water is then extracted from the reactor.

### 7.2. EXAMPLE OF A PLANT FOR TREATING WATER TO IMPLEMENT A METHOD ACCORDING TO THE INVENTION

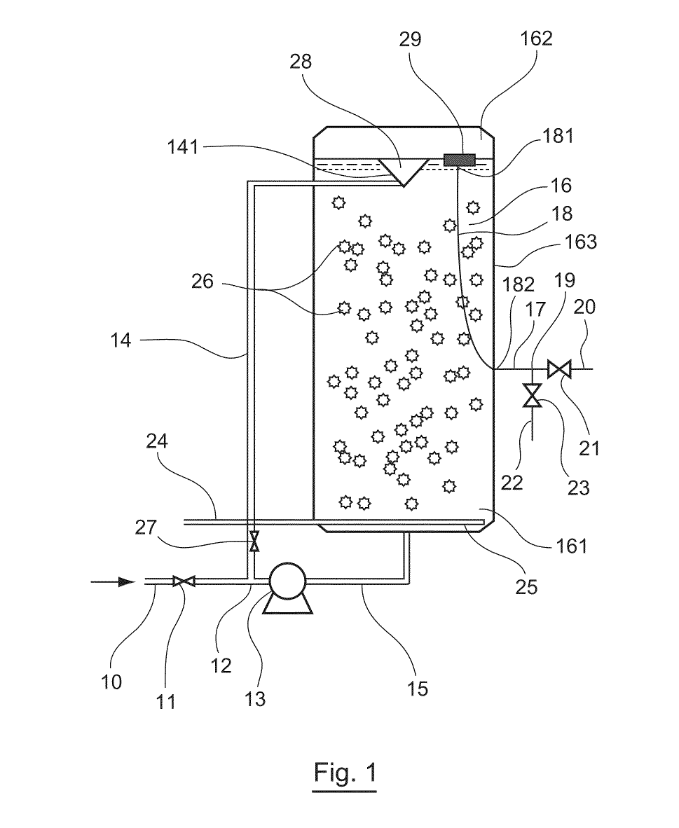

Referring to FIG. 1, we present a plant for treating water to implement a method according to the invention.

As represented, a plant of this kind comprises a water intake pipe 10 for leading in water to be treated. The outlet of this pipe is connected to the inlet of a T-connector 12. A valve 11 is mounted on the pipe 10.

The T-connector 12 comprises an outlet that is connected to the inlet of a recirculation pump 13. The T-connector 12 comprises a second inlet that is connected to the outlet of a recirculation pipe 14 on which a valve 27 is mounted.

The outlet of the recirculation pump 13 is connected to a collector 15 which opens into the bottom of a biological reactor 16.

The biological reactor 16 comprises a bottom 161, a top part 162 and a side wall 163. The side wall 163 is crossed by an extraction mouth 17.

The reactor 16 houses means for extracting treated water and/or particles. These means for extracting comprise a tube 18. The inlet 181 of this tube 18 is provided with a floater 29. The outlet 182 of this tube 18 is connected to the extraction mouth 17.

The extraction mouth 17 is connected to a T-connector 19. A first outlet of this T-connector 19 is connected to a pipe 20 for removing treated water on which a valve 21 is mounted and a second outlet of this T-connector 19 is connected to a pipe 22 for removing particles of low decanting capacity and granules on which a valve 23 is mounted.

The plant comprises means for aerating the reactor 16. These means for aerating comprise an air intake pipe 24, the outlet of which is connected to a distributor unit 25 housed at the bottom of 161 of the reactor 16.

The reactor 16 houses a bed constituted by a plurality of biomass granules 26.

The recirculation pipe 14 comprises an inlet 141 that is connected to a funnel 28 placed in the top part 162 of the reactor 16. In one variant, this recirculation could be done by using the pipe 20 for removing treated water.

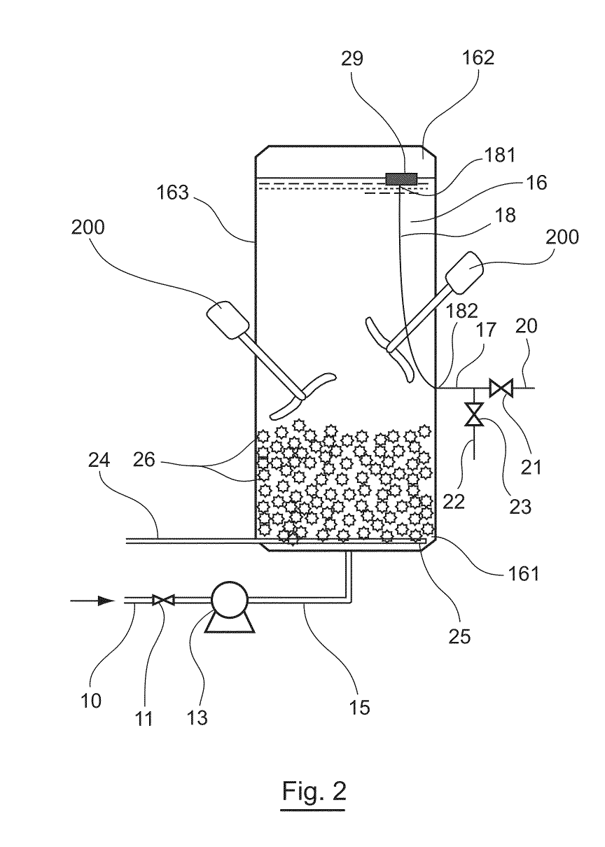

FIG. 2 illustrates a variant of the plant for treating water illustrated in FIG. 1.

As can be seen in FIG. 2, the means for recirculating water which comprise especially the funnel 28 and the pipe 14 for recirculating are replaced in this variant by blade stirrers 200 housed within the reactor 16.

### 7.3. EXAMPLE OF A METHOD FOR TREATING WATER ACCORDING TO THE INVENTION

During the implementing of a method for treating water according to the invention, the biological reactor 16 works in sequenced mode as shall be explained in detail here below. This is therefore a reactor of the SBR (sequenced batch reactor) type in which the total volume of water to be treated is treated by successive portions or batches.

A method according to the invention comprises a plurality of successive cycles each comprising:

an anaerobic step for feeding wastewater to the reactor 16 during which the water is mixed with the granules to form a fluidized bed;

an anaerobic step for stirring the contents of the reactor 16;

a step for aerating the content of the reactor 16;

a decantation step;

a step for removing treated water depleted of organic matter.

During each feeding step, the valve 11 is open while the valves 27,21 and 23 are closed. The pump 13 is implemented in such a way that the water to be treated is introduced into the reactor 16 from its bottom 161 via the intake pipe 10, the collector 15 and the conduits 151, preferably until the top level of the reactor 16 is reached.

The speed at which water is fed to the reactor during the feeding step ranges from 10 to 20 m/h. The feeding of water to be treated to the reactor is therefore fast.

Owing to the fast feed, the water to be treated rapidly passes through the bed of granules present at the bottom of the reactor 16 in such a way that the bed is fluidized. Thus, the totality of the granules constituting the bed is swiftly exposed to the water to be treated on the totality of their surface. Thus, as soon as the water is fed to the reactor, the exchanges between the water to be treated and the biomass constituting the granules are maximized. In other words, as soon as the feeding of the reactor is done, the granules start assimilating nutrients.

After the feeding of water to the reactor is completed, its content is kept stirred in anaerobic conditions.

During this anaerobic stirring step, the stirring within the reactor 16 is generated by the implementation of stirring means.

In the embodiment illustrated in FIG. 1, the valve 11 is closed, the valve 27 is open and the pump 13 is implemented in such a way that the water contained in the reactor 16 is sucked into the funnel 28 situated at the upper part 162 of the reactor 16 and flows into the recirculation pipe 14 and is then re-injected into the bottom 161 of the reactor 16 via the collector 15 and the conduits 151. During this aerobic stirring phase, the speed of recirculation of the water ranges from 4 to 8 m/h.

In the embodiment illustrated in FIG. 2, the stirring is generated in the reactor 16 by putting the blade stirrers 200 into rotation.

The implementing of the stirring means in the anaerobic stirring step creates a level of stirring within the reactor ranging from 5 to 10 W/m³.

Such a level of stirring improves the exchanges between the water to be treated and the biomass granules while at the same time preserving their integrity.

The stirring within the reactor ensures that the granules come into contact continuously with the water on the totality of their surface throughout the duration of the stirring phase. The nutrients, whose assimilation by the granules is not limited by the diffusion, can penetrate in depth into the granules. The rate of assimilation of the nutrients by the granules is therefore greater than when implementing the technique according to the prior art. This also increases the speed at which the PO₄—P which is necessary for the biological dephosphatation by PAO bacteria.

Given the improvement of exchanges between water and the granules, the implementing of the technique of the invention, which promotes the development of the granules, leads to the production of stable granules, i.e. solid granules having high density and volume and therefore high capacity for being decanted.

The diameter of the granules thus obtained is generally ranges from 1 to 5 mm while their density generally ranges from 1.03 to 1.5 kg/l.

The technique of the invention also improves the reduction of the nutrients, especially phosphorous and nitrogen.

After the anaerobic stirring step is completed, a step of aeration of the contents of the reactor is implemented.

The valve 27 is then closed, the pump 13 stopped and air or another gas containing oxygen is introduced into the bottom of the reactor 16 via the pipe 24 and the distributor unit 25. The concentration in dissolved oxygen in the reactor generally ranges from 1 to 4 mg O₂/l.

A part of the bacteria forming the biomass, of which the granules are constituted, converts the ammonia present in the water in nitrates by consuming oxygen. A nitrification of the water is then observed.

Given the thickness of the granules, there is a gradient of concentration in oxygen: the oxygen concentration within the granules decreases with depth. Thus, the oxygen concentration at the core of the granules is substantially zero.

Another part of the bacteria forming the biomass constituting the granules then degrade the previously produced nitrates into nitrogen gas in an anoxic phase. Then a denitrification of the water is observed. Thus, the phosphorus jettisoned during the anaerobic step will be accumulated in the granules.

After the aeration step is completed by stopping the injection of oxygen into the reactor 16, the granules formed in the reactor 16 swiftly decant because of their size. During the decanting phase, the granules of high decanting capacity collect at the bottom of the reactor 16.

The treated water, depleted of organic matter as well as nutrients, can then be extracted from the reactor 16. To this end, the valve 21 is opened so that the water treated flows from the inlet 181 of the tube 18 floating on the surface of the water. Since the inlet 181 of the tube 18 floats on the surface of the water, it is possible to activate the extraction of treated water by opening the valve 21 without waiting for all the granules to be decanted at the bottom of the reactor 16. The flow rate of extraction of treated water can thus be chosen so that the lowering of the level of water in the reactor follows the lowering of the level of granules in the reactor. The production time for treated water can thus be reduced. The speed of extraction of the water will preferably range from 10 to 20 m/h.

The level of the extraction point for the treated water, in other words the level of the inlet 181 of the tube 18, is variable and, in this case, falls during the extraction. It is thus possible to lower the level of the inlet 181 of the tube 18 until it reaches a level close to that of the surface of the bed of granules. Thus, it becomes possible to extract a very great volume of treated water, and the volume of treated water stagnating within the reactor 14 is reduced accordingly after completion of the step for extracting.

As a result, at the next filling of the reactor 16, the water to be treated that is introduced is little diluted with already treated stagnant water whose concentration in nutrients for the biomass is very low. The development of the granules at the following cycles is also promoted.

In addition to the granules of high decanting capacity, the water contained in the reactor contains other less decantable particles. During the decantation phase, these particles tend to collect to form a layer on the surface of the bed of granules situated at the bottom of the reactor 16.

Thus, during the step for extracting the treated water, the inlet 181 of the tube is in proximity to the upper surface of the bed of granules, and the valve 21 can be closed and the valve 23 opened so that the particles of low decanting capacity can be extracted from the reactor 16 separately from the treated water. The treated water extracted from the reactor 16 thus has a low rate of solid particles in suspension. Thus, the implementation of a polishing treatment downstream is avoided. The particles of low decanting capacity extracted from the reactor 16 can be sent to subsequent treatment. It can happen that such a step for extracting the particles of low decanting capacity is not implemented at each cycle.

After the step for extracting treated water is completed, a new cycle can be initiated by implementing a new anaerobic step for the fast feeding of the reactor 16. As many cycles as necessary will be implemented to carry out the treatment of a given volume of water to be treated.

A method according to the invention can include one or more steps for extracting granules. This step or these steps for extracting granules are preferably implemented after the running of several successive cycles.

The granules can be extracted at the end of a step for extracting particles of low decanting capacity by leaving the valve 23 open.

The step for extracting granules is preceded by a step for stirring the content of the reactor 16. The stirring can be generated mechanically using stirrers. It is preferably generated by aerating the interior of the reactor through the piping 24 and the distribution unit 25.

In this way, the bed of granules is stirred so that the distribution of the GAOs and the PAOs contained in the granules is substantially homogenous within the bed. Thus, during the extraction of granules, the proportions of GAOs and PAOs discharged from the reactor 16 is substantially identical. Thus, the GAOs are prevented from being preponderant within the reactor at the subsequent cycles. Such preponderance would limit the reduction of the phosphorous.

The aeration of the bed before extraction of granules also makes it possible to maintain an aerobic state within the reactor 16 and prevent a part of the phosphorous assimilated by the granules from being rejected into the reactor before the discharge of the granules. This contributes to improving the reduction of the phosphorous.

During the implementing of such a method, the duration of the step for:

anaerobic feeding is equal to 15 minutes and preferably ranges from 10 to 30 minutes;

anaerobic stirring is equal to 45 minutes and preferably ranges from 30 to 60 minutes;

aeration is equal to 120 minutes and preferably ranges from 90 to 180 minutes;

decantation is equal to 15 minutes and preferably ranges from 10 to 30 minutes;

extracting treated water is equal to 15 minutes and preferably ranges from 10 to 30 minutes.

In the prior-art technique implementing an SBR type reactor without granules, the duration of the step for:

feeding and latency is equal to 1 to 2 hours;

aeration is equal to 2 hours;

decantation is equal to 1 hour;

extracting treated water is equal to 1 hour.

In the invention technique implementing granules, the duration of the step for:

feeding and latency is equal to 1 to 2 hours;

aeration is equal to 2 hours;

decantation is equal to 2-10 minutes;

extracting treated water is equal to 2-10 minutes.

The implementing of the technique according to the invention thus reduces the duration of the treatment.

1-13. (canceled)

14. A method of biologically treating wastewater containing organic matter within a reactor by employing biomass granules comprising:
anaerobically treating the wastewater by feeding the wastewater into a lower portion of the reactor at a speed sufficient to mix the wastewater with the biomass granules and form a fluidized bed wherein the biomass granules are fluidized and remove nutrients from the wastewater passing through the fluidized biomass granules while the wastewater is fed into the reactor;
after feeding the wastewater into the reactor and forming the fluidized bed of biomass granules, under anaerobic conditions stirring the wastewater and the biomass granules in the reactor;
aerating the wastewater and biomass granules;
decanting the wastewater; and
discharging treated wastewater having organic matter removed therefrom.

15. The method of claim 14 including feeding the wastewater into the reactor at a speed of 10 to 20 m/h.

16. The method of claim 14 including feeding the wastewater into the reactor at a speed of 10 to 20 m³/m²/h where m³ corresponds to a volume of water and m² corresponds to the surface area of the reactor.

17. The method of claim 14 wherein stirring the wastewater and biomass granules includes circulating the wastewater through the reactor.

18. The method of claim 17 wherein circulating the wastewater through the reactor comprises removing at least a portion of the wastewater from the reactor and returning at least a portion of the wastewater removed from the reactor back to the reactor.

19. The method of claim 14 wherein stirring the wastewater and biomass granules comprises utilizing one or more mixers in the reactor to mix and stir the wastewater and biomass granules in the reactor.

20. The method of claim 14 wherein the level of stirring within the reactor during the anaerobic step of stirring ranges from 5 to 10 W/m³.

21. The method of claim 14 wherein the level of the wastewater being discharged from the reactor during the step of discharging treated water is variable.

22. The method of claim 14 wherein the method recited therein is repeated for a plurality of cycles with each cycle producing treated wastewater, and wherein the method includes extracting biomass granules from the reactor after running two or more cycles.

23. The method of claim 22 wherein extracting biomass granules is preceded by stirring the wastewater and biomass granules in the reactor.

24. The method of claim 14 including extracting biomass granules from the reactor without simultaneously extracting treated wastewater from the reactor.

25. The method of claim 14 wherein the biomass granules have a diameter greater than one millimeter.

26. The method of claim 14 wherein decanting the wastewater includes directing wastewater from an upper portion of the reactor downwardly to an outlet located at a point generally intermediately between the upper portion of the reactor and a lower portion of the reactor, and directing the wastewater from the reactor via the outlet.

27. The method of claim 26 wherein the outlet is disposed generally midway the height of the reactor, and wherein there is provided a line connected between a floating inlet and the outlet, and wherein decanting the wastewater includes directing wastewater from the upper portion of the wastewater in the reactor into the floating inlet and therefrom downwardly to the outlet where treated wastewater is discharged from the reactor.

28. The method of claim 14 wherein decanting the wastewater comprises removing treated wastewater from the reactor and directing at least a portion of the treated wastewater back into the reactor where the treated wastewater is circulated through the reactor.

29. The method of claim 14 including generally maintaining the density of the biomass granules at greater than 1 kg/L.

30. The method of claim 14 including varying the level of an extraction point for the treated wastewater while decanting the wastewater.

31. The method of claim 14 wherein feeding the wastewater into the reactor occurs for a time period of 10 to 30 minutes; wherein the anaerobic stirring occurs for a time period of 30 to 60 minutes; wherein aerating the wastewater in the reactor occurs for a time period of 90 to 180 minutes; and wherein decanting the wastewater occurs for a time period of 10 to 30 minutes.

32. A method of biologically treating wastewater having organic matter in a sequencing batch reactor that includes biomass granules, the method comprising:
feeding wastewater to be treated into the sequencing batch reactor;
during feeding the wastewater into the sequencing batch reactor, directing the wastewater to be treated into the reactor at a sufficient speed to fluidize the biomass granules in the reactor such that the wastewater is treated in a fluidized bed of biomass granules during feeding;
after feeding the wastewater into the sequencing batch reactor, stirring the wastewater and biomass granules in the sequencing batch reactor for a selected time period;
after stirring the biomass granules and wastewater in the sequencing batch reactor, aerating the wastewater and biomass granules in the reactor for a selected period of time; and
after aerating, decanting the contents of the sequencing batch reactor and discharging from the sequencing batch reactor treated wastewater that has at least some organic matter removed therefrom.

33. The method of claim 32 wherein the wastewater to be treated is fed upwardly through a bottom portion of the sequencing batch reactor; and wherein stirring the biomass granules and wastewater in the reactor comprises mixing the contents of the reactor with one or more mixers or circulating the wastewater through the reactor.

34. The method of claim 32 including extracting at least some biomass granules from an extraction point in the reactor that lies generally midway between a top portion of the reactor and a bottom portion of the reactor.

35. The method of claim 32 wherein treated wastewater is extracted from the reactor at various levels in the reactor during decanting.

36. The method of claim 32 including decanting treated wastewater by directing treated wastewater in the reactor into a floating inlet of a conduit and directing the treated wastewater downwardly from the floating inlet to an outlet in the reactor which is located intermediately between top and bottom portions of the sequencing batch reactor such that during decanting the treated wastewater, the level of the inlet in the reactor varies.

37. The method of claim 32 wherein the speed at which the wastewater is fed into said sequencing batch reactor is from 10 to 20 m/h or m³/m²/h.

38. The method of claim 32 wherein feeding the wastewater to be treated into the reactor and stirring the contents of the reactor occurs generally under anaerobic conditions.
